(19) United States
(12) Patent Application Publication
(10) Pub. No.: US 2016/0300425 A1
(43) Pub. Date: Oct. 13, 2016

(54) METHOD, SYSTEM AND GRAPHICAL USER INTERFACE FOR PENDING WAGERS

(71) Applicant: iPro, Inc., Incline Village, NV (US)

(72) Inventors: Shanmugapriyan DEVARAJ, Portland, OR (US); David ORTIZ, Newcastle, WA (US)

(21) Appl. No.: 14/849,416

(22) Filed: Sep. 9, 2015

Related U.S. Application Data
(63) Continuation-in-part of application No. 14/684,077, filed on Apr. 10, 2015.
Application No. 14/684,077 is a continuation-in-part of application No. 14/684,099, filed on Apr. 10, 2015.
Application No. 14/684,099 is a continuation-in-part of application No. 14/684,134, filed on Apr. 10, 2015.
Application No. 14/684,134 is a continuation-in-part of application No. 14/684,161, filed on Apr. 10, 2015.
Application No. 14/684,161 is a continuation-in-part of application No. 14/684,184, filed on Apr. 10, 2015.
Application No. 14/684,184 is a continuation-in-part of application No. 14/684,210, filed on Apr. 10, 2015.
Application No. 14/684,210 is a continuation-in-part of application No. 14/821,469, filed on Aug. 7, 2015.

(51) Int. Cl. G07F 17/32; G06T 13/80; G06F 3/0488; G06F 3/0481; G06F 3/0482

(52) U.S. Cl. CPC G07F 17/3204; G06F 3/04817; G06F 3/0482; G06F 3/04883; G06T 13/80; G07F 17/3211; G07F 17/3288; G07F 17/3209; G06T 2200/24

(57) ABSTRACT

Methods, systems and graphical user interfaces for pending wagers. In accordance with an embodiment of the present invention, a computer-implemented method includes displaying an icon on a graphical user interface corresponding to an accepted wager. The method may additionally include accessing an instruction to open a first bet on a first micro event, displaying a user interface to accept the first bet on the first micro event, and accepting the first bet on the first micro event to create the accepted wager. The method may further include accessing an instruction to open a second bet on a second micro event and displaying a user interface to accept the second bet on the second micro event.

### RELATED APPLICATIONS

This application is a Continuation-in-Part of co-pending, commonly owned U.S. patent application Ser. No. 14/684,077, attorney docket IPRO-0001-01.01US, filed Apr. 10, 2015, entitled “Method and System for Seamless Transitions between Game Types for Portable Computer Systems” to Devaraj et al., and is hereby incorporated by reference herein in its entirety.

This application is a Continuation-in-Part of co-pending, commonly owned U.S. patent application Ser. No. 14/684,099, attorney docket IPRO-0002-01.01US, filed Apr. 10, 2015, entitled “System and Method for Accepting and Creating Electronic Wagers” to Ortiz et al., and is hereby incorporated by reference herein in its entirety.

This application is a Continuation-in-Part of co-pending, commonly owned U.S. patent application Ser. No. 14/684,134, attorney docket IPRO-0003-01.01US, filed Apr. 10, 2015, entitled “System and Method for On-line Wagering on Real Time Events” to Ortiz et al., and is hereby incorporated by reference herein in its entirety.

This application is a Continuation-in-Part of co-pending, commonly owned U.S. patent application Ser. No. 14/684,161, attorney docket IPRO-0004-01.01US, filed Apr. 10, 2015, entitled “System and Method for On-line Fantasy Wagering” to Ortiz et al., and is hereby incorporated by reference herein in its entirety.

This application is a Continuation-in-Part of co-pending, commonly owned U.S. patent application Ser. No. 14/684,184, attorney docket IPRO-0005-01.01US, filed Apr. 10, 2015, entitled “System and Method for On-Line Multi-Player Interactive Wagering” to Devaraj et al., and is hereby incorporated by reference herein in its entirety.

This application is a Continuation-in-Part of co-pending, commonly owned U.S. patent application Ser. No. 14/684,210, attorney docket IPRO-0006-01.01US, filed Apr. 10, 2015, entitled “Graphical User Interface for On-Line Gaming” to Ortiz et al., and is hereby incorporated by reference herein in its entirety.

This application is a Continuation-in-Part of co-pending, commonly owned U.S. patent application Ser. No. 14/821,469, attorney docket IPRO-0007-01.01US, filed Aug. 7, 2015, entitled “Method and System for Dynamic Determining of Odds for Live Events Betting” to Devaraj et al., and is hereby incorporated by reference herein in its entirety.

U.S. Pat. No. 8,790,176, entitled “System and Method for Real Time Interactive Entertainment” to Hopf and Ortiz, is hereby incorporated by reference in its entirety.

### FIELD OF INVENTION

Embodiments of the present invention relate to the field of electronic applications for mobile computer systems. More specifically, embodiments of the present invention relate to systems, methods and graphical user interfaces for wagers.

### BACKGROUND

On-line wagering on live events is a growing form of interactive amusement. Under the conventional art, some on-line live events wagering systems present a user, or player, with opportunities to place successive wagers on various aspects of live events, e.g., a series of bets on a series of plays in a sporting contest. Unfortunately, under the conventional art, a live event is often not synchronized with the availability of machine-usable information of the live event.

For example, a viewer of a live televised sporting contest may observe the results of a play essentially “live,” e.g., with only a minimal transmission delay through a broadcast network. In contrast, the production of machine-usable information of such a play typically involves one or more persons watching the play, e.g., at the venue or on television, and manually entering information of the play into a computer system, which is then processed and distributed via a second communications network. In addition to a time required for the manual entry of information and subsequent processing, it is to be appreciated that the second communications network is typically a packet-switched network, having different, e.g., generally longer, transmission delay characteristics in comparison to the first communications network. Thus, there are numerous factors that contribute to a noticeable delay in the availability of the machine-usable information of a live event relative to the actual event. This problem is known as or referred to as latency in the resolution of a live event.

Due to such delays in the availability of the machine-usable information of a live event, under the conventional art, a subsequent wagering opportunity is often precluded pending resolution of a previous wager. For example, a bet on a second play may not be accepted until a bet on a first, prior, play is resolved. Resolution of the bet on the first play generally depends on the availability of the machine-usable information for the live event. While waiting for the first bet to be resolved, the second play may unfortunately begin without an opportunity to bet on the second play.

### SUMMARY OF THE INVENTION

Therefore, what is needed are methods, systems and graphical user interfaces for handling pending wagers, e.g., wagers that have not yet been resolved. What is additionally needed are methods, systems and graphical user interfaces for pending wagers that decouple subsequent wagering from the resolution of prior wagers. A need also exists for methods, systems and graphical user interfaces for pending wagers that indicate a number and/or order of the pending wagers. Further, a need exists for methods, systems and graphical user interfaces for pending wagers that are compatible and complementary with existing systems and methods of on-line and/or mobile gaming platforms. Embodiments of the present invention provide these advantages and enhance the user's experience.

In accordance with a method embodiment of the present invention, a computer-implemented method is described that includes displaying an icon on a graphical user interface corresponding to an accepted wager. The method may additionally include accessing an instruction to open a first bet on a first micro event, displaying a user interface to accept the first bet on the first micro event, and accepting the first bet on the first micro event to create the accepted wager. The method may further include accessing an instruction to open a second bet on a second micro event and displaying a user interface to accept the second bet on the second micro event.

In accordance with an embodiment of the present invention, a mobile electronic system described that includes one or more processors coupled to a bus, a memory coupled to the one or more processors, wherein the memory includes a gaming application, a position determining system coupled to the bus operable to determine a geolocation of the electronic system and a graphical user interface coupled to the bus. The mobile electronic system is configured to access an instruction to open a first bet on a first micro event, display a user interface to accept the first bet on the first micro event, and to accept the first bet on the first micro event to create the first bet. The mobile electronic system is also configured to access an instruction to open a second bet on a second micro event, display an icon corresponding to the first bet, and to display a user interface to accept the second bet on the second micro event.

In accordance with an embodiment of the present invention, a graphical user interface described that includes a first region for indicating details of a wager on a future micro event and a second region for displaying at least one icon corresponding to a wager on a prior micro event pending resolution. The second region may include a numerical indication of a number of pending wagers. The second region may be configured to display a list of all pending wagers responsive to a touch input in the second region.

### BRIEF DESCRIPTION OF THE DRAWINGS

The accompanying drawings, which are incorporated in and form an integral part of this specification, illustrate embodiments of the invention and, together with the description, serve to explain the principles of the invention. Unless otherwise noted, the drawings are not drawn to scale.

FIG. 1 illustrates an exemplary block diagram of an exemplary electronic system, which may be used as a platform to implement embodiments of the present invention.

FIG. 2 illustrates an exemplary data flow, in accordance with embodiments of the present invention.

FIG. 3 illustrates an exemplary data flow in a system for handling pending wagers, in accordance with embodiments of the present invention.

FIG. 4 illustrates an exemplary time line of wagering system events corresponding to game events, in accordance with embodiments of the present invention.

FIG. 5 illustrates an exemplary on-screen graphical user interface (GUI) for placing a wager on team results of a micro event, in accordance with embodiments of the present invention.

FIG. 6 illustrates an exemplary on-screen graphical user interface (GUI) for placing a wager on team results of a micro event, in accordance with embodiments of the present invention.

FIG. 7 illustrates an exemplary on-screen graphical user interface (GUI), in accordance with embodiments of the present invention.

FIG. 8 illustrates an exemplary computer-implemented method, in accordance with embodiments of the present invention.

FIG. 9 illustrates an exemplary method, in accordance with embodiments of the present invention.

FIG. 10 illustrates an exemplary computer-implemented method of wagering, in accordance with embodiments of the present invention.

### DETAILED DESCRIPTION

Reference will now be made in detail to various embodiments of the present invention, examples of which are illustrated in the accompanying drawings. While the invention will be described in conjunction with these embodiments, it is understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the invention, numerous specific details are set forth in order to provide a thorough understanding of the invention. However, it will be recognized by one of ordinary skill in the art that the invention may be practiced without these specific details. In other instances, well known methods, procedures, components, and circuits have not been described in detail as not to unnecessarily obscure aspects of the invention.

### NOTATION AND NOMENCLATURE

Some portions of the detailed descriptions which follow (e.g., methods 800, 900 and 1000) are presented in terms of procedures, steps, logic blocks, processing, and other symbolic representations of operations on data bits that may be performed on computer memory. These descriptions and representations are the means used by those skilled in the data processing arts to most effectively convey the substance of their work to others skilled in the art. A procedure, computer executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, data, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “resolving” or “accepting” or “selecting” or “determining” or “displaying” or “presenting” or “computing” or “sending” or “receiving” or “reducing” or “detecting” or “setting” or “accessing” or “placing” or “testing” or “forming” or “mounting” or “removing” or “ceasing” or “stopping” or “coating” or “processing” or “performing” or “generating” or “adjusting” or “creating” or “executing” or “continuing” or “indexing” or “translating” or “calculating” or “measuring” or “gathering” or “running” or the like, refer to the action and processes of, or under the control of, a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The meaning of “non-transitory computer-readable medium” should be construed to exclude only those types of transitory computer-readable media which were found to fall outside the scope of patentable subject matter under 35 U.S.C. §101 in In re Nuiften, 500 F.3d 1346, 1356-57 (Fed. Cir. 2007). The use of this term is to be understood to remove only propagating transitory signals per se from the claim scope and does not relinquish rights to all standard computer-readable media that are not only propagating transitory signals per se.

The terms “micro event” and “sub-event” are used to refer to or to describe an activity within a larger “event,” the outcome of which may be subject to a wager. For example, a football game may be considered an “event,” while individual plays within the game may be considered “micro events.” Similarly, a baseball game may be considered an “event,” while each pitch, and the resulting outcome, e.g., ball, strike, single, double, triple, home run, sacrifice fly, etc., may be considered a “micro event,” or the result of a micro event. As a further example, an automobile race may be considered an “event,” while individual laps, pit stop durations, and/or crashes may be considered “micro events.”

Other live events may not be considered sporting events. For example, television game shows may be live events. In such events, individual rounds and/or contestant's performance(s) may be considered micro events of the larger event.

For games or other live events with a less defined play structure, e.g., basketball or soccer, a fixed duration of game time, e.g., five minutes, may constitute a “micro event.”

It is appreciated, however, that such games or events may comprise discernable micro events. For example, in a game of basketball, the result(s) of free throws, three-point shots and/or rebounds may be considered micro events. Such micro events may be used in determining odds even if, for example, an on-line wagering system does not allow a user to bet on those same micro events. For example, dynamic statistics on three-point shooting may be used to determine odds of a team scoring a particular number of points in a five-minute interval. Embodiments in accordance with the present invention are well suited to wagers based on events and micro events within such events.

In the disclosure herein, embodiments in accordance with the present invention are presented in terms of an exemplary football game. It is to be appreciated, however, that embodiments in accordance with the present invention are well suited to wagering on a variety of other live events, and systems of wagers on such events are considered within the scope of the present invention. Such live events may include, for example, sporting contests, video games, reality and dating television shows, competition television shows, televised talent shows, current events, celebrity news, stocks and/or businesses, news stories, elections, governance actions, e.g., Congressional votes, civil and/or criminal trial verdicts, military actions, space exploration, weather events, pools on event timing, e.g., births, bankruptcy, earthquakes of a particular magnitude, and the like.

The subjects included in wagering opportunities may be determined from any suitable source of event information, including, for example, detecting subjects that are “trending” on social media, e.g., Twitter, Reddit, on search engines, e.g., Google, via news stories on press “wire” services, e.g., from the Associated Press (AP), Google News, BBC, a televised news “ticker” service, e.g., from Cable News Network (CNN) and the like. Wager categories, and/or corresponding specific wagers, may be created automatically, e.g., via a computer-implemented process, or manually, in some embodiments. It is to be appreciated that an event or event category need not be televised, live or delayed, to be included in a list of wager categories.

### Method, System and Graphical User Interface for Pending Wagers

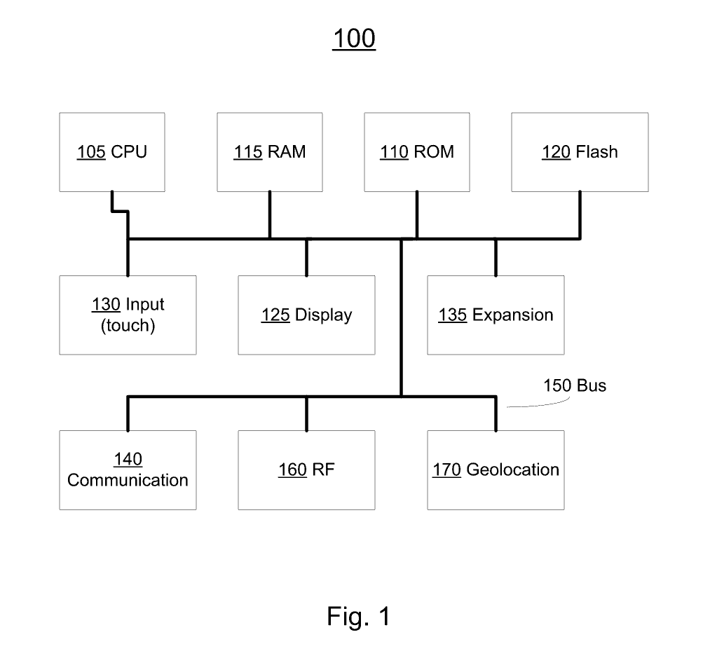

FIG. 1 illustrates an exemplary block diagram of an exemplary electronic system 100, which may be used as a platform to implement embodiments of the present invention. Electronic system 100 may be battery-powered, in some embodiments. Electronic system 100 may be a “server” computer system, in some embodiments. Electronic system 100 may comprise a desktop or generally “fixed location” computer system, in some embodiments. Electronic system 100 may comprise a portable computer system, e.g., a “smart” phone. Electronic system 100 may comprise a “wearable” computer system, e.g., a “smart” watch or an “eye-glasses-mounted” computer system. Electronic system 100 includes an address/data bus 150 for communicating information, a central processor 105 functionally coupled with the bus for processing information and instructions. Central processor 105 may comprise a single processor or multiple processors, e.g., a multi-core processor, or multiple separate processors, in some embodiments. Electronic system 100 also includes a volatile memory 115 (e.g., random access memory RAM) coupled with the bus 150 for storing information and instructions for the central processor 105, and a non-volatile memory 110 (e.g., read only memory ROM) coupled with the bus 150 for storing static information and instructions for the processor 105. Electronic system 100 also optionally includes a changeable, non-volatile memory 120 (e.g., flash) for storing information and instructions for the central processor 105 which can be updated after the manufacture of system 100. In some embodiments, only one of ROM 110 or Flash 120 may be present.

Also included in electronic system 100 of FIG. 1 is an optional input device 130. Device 130 can communicate information and command selections to the central processor 100. Input device 130 may be any suitable device for communicating information and/or commands to the electronic system 100. For example, input device 130 may take the form of a keyboard, buttons, a joystick, a track ball, an audio transducer, e.g., a microphone, a touch sensitive digitizer panel, eyeball scanner and/or the like. A touch sensitive digitizer panel may comprise any suitable technology, e.g., capacitive, resistive, optical, acoustic and/or pressure responsive touch panels. Activation of a “touch” sensitive digitizer panel may not require actual touching of the panel 130 or the electronic system 100, in some embodiments. For example, capacitive touch panels may sense proximity of a user's finger or an eyeball scanner may detect a direction of a user's gaze.

The display unit 125 utilized with the electronic system 100 may comprise a liquid crystal display (LCD) device, cathode ray tube (CRT), field emission device (FED, also called flat panel CRT), light emitting diode (LED), plasma display device, electro-luminescent display, electronic paper, electronic ink (e-ink) or other display device suitable for creating graphic images and/or alphanumeric characters recognizable to the user. Display unit 125 may have an associated lighting device, in some embodiments. Display unit 125 may comprise a head-mounted display, in some embodiments.

The touch sensitive digitizer panel 130 is generally associated with the display unit 125. For example, a function of the touch sensitive digitizer panel 130 generally associated with the display unit 125 is to localize a touch input, e.g., from a finger or stylus, to a portion of display unit 125, for example, a single icon image displayed on display unit 125. The touch sensitive digitizer panel may be in front of the actual display device, e.g., in a viewer's optical path, or the touch sensitive digitizer panel may be outside of a viewer's optical path, e.g., behind or to the side of the display device. The touch sensitive digitizer panel 130 may have different planar dimensions in comparison to planar dimensions of a display unit 125. For example, the touch sensitive digitizer panel 130 may be smaller than display unit 125, e.g., the display unit 125 may extend beyond the touch sensitive digitizer panel 130. Similarly, the touch sensitive digitizer panel 130 may be larger than display unit 125, e.g., the touch panel may extend beyond the display unit. The touch sensitive digitizer panel may be integral to a display assembly, or a separate assembly within the electronic system 100. A touch sensitive digitizer panel is not required.

Electronic system 100 also optionally includes an expansion interface 135 coupled with the bus 150. Expansion interface 135 can implement many well known standard expansion interfaces, including without limitation the Secure Digital Card interface, universal serial bus (USB) interface, Compact Flash, Personal Computer (PC) Card interface, CardBus, Peripheral Component Interconnect (PCI) interface, Peripheral Component Interconnect Express (PCI Express), mini-PCI interface, IEEE 1394, Small Computer System Interface (SCSI), Personal Computer Memory Card International Association (PCMCIA) interface, Industry Standard Architecture (ISA) interface, RS-232 interface, and/or the like. In some embodiments of the present invention, expansion interface 135 may comprise signals substantially compliant with the signals of bus 150.

A wide variety of well-known devices may be attached to electronic system 100 via the bus 150 and/or expansion interface 135. Examples of such devices include without limitation rotating magnetic memory devices, flash memory devices, digital cameras, wireless communication modules, digital audio players, biometric monitors and/or Global Positioning System (GPS) devices.

System 100 also optionally includes a communication port 50. Communication port 50 may be implemented as part of expansion interface 135. When implemented as a separate interface, communication port 50 may typically be used to exchange information with other devices via communication-oriented data transfer protocols. Examples of communication ports include without limitation RS-232 ports, universal asynchronous receiver transmitters (UARTs), USB ports, infrared light transceivers, ethernet ports, IEEE 1394 and synchronous ports.

System 100 optionally includes a radio frequency module 160, which may implement a mobile telephone, a wireless network, e.g., IEEE 802.11 (“Wi-Fi”), Bluetooth, a pager, or a digital data link. Radio frequency module 160 may be interfaced directly to bus 150, via communication port 50, via expansion interface 135, or any suitable interface. Various features of electronic system 100 may be implemented by a combination of hardware and/or software. Electronic system 100 may comprise additional software and/or hardware features (not shown) in some embodiments.

Various modules of system 100 may access computer readable media, and the term is known or understood to include removable media, for example, Secure Digital (“SD”) cards, CD and/or DVD ROMs, diskettes and the like, as well as non-removable or internal media, for example, hard drives, RAM, ROM, flash, and the like.

Electronic system 100 may comprise one or more geolocation determining features 170. For example, electronic system 100 may determine its position by use of a Global Positioning System (GPS), including, for example, the United States Global Position System, the planned European Union Galileo positioning system, India's Indian Regional Navigational Satellite System and/or the Chinese Compass navigation system. Electronic system 100 may also determine its position via a mobile telephone network, for example, identifying, measuring signal strength, and/or triangulation of cell towers. Electronic system 100 may also determine its position from known locations of wireless networks, e.g., WiFi hotspots, from an internet protocol (IP) address, or any other applicable location service(s). Geolocation determining features 170 may comprise dedicated hardware, or may utilize components with one or more other uses.

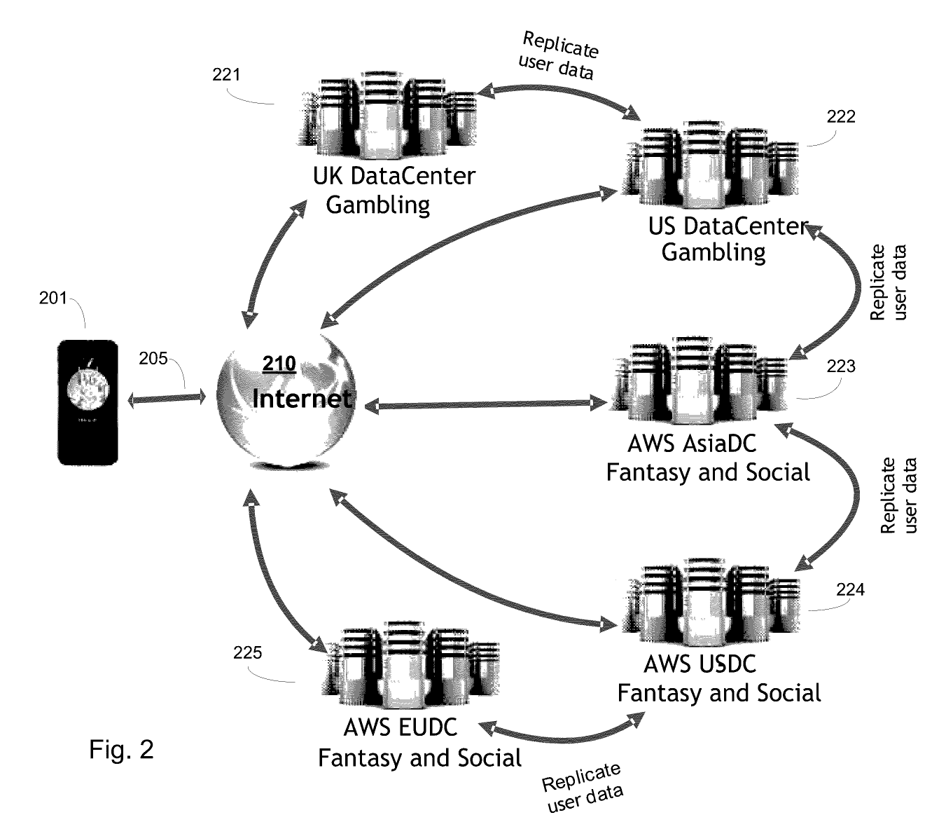

FIG. 2 illustrates an exemplary data flow, in accordance with embodiments of the present invention. Computer system 201, which may be a portable or non-portable embodiment of exemplary electronic system 100 as illustrated in FIG. 1, communicates 205 with the internet 210. The communication may take any suitable form, for example, via mobile data or a wireless local area network (LAN). In accordance with embodiments of the present invention, one such communication may comprise information of a live event, e.g., a sporting event, of interest to a user of computer system 201. The information is forwarded to one of a plurality of regional data centers 221, 222, 223, 224, 225. The information may be forwarded to a closest data center, or the information may be forwarded to an arbitrary data center, in accordance with embodiments of the present invention.

The regional data centers 221, 222, 223, 224, 225 each cover a defined territory, which may overlap. Each regional data center is configured to provide odds related information on a variety of sporting events. The sporting events may be restricted to events within a data center's defined territory, in some embodiments. In accordance with embodiments of the present invention, a data center may provide odds related information on sporting events outside of a data center's defined territory.

Once the information is received at a regional data center, e.g., “UK Data Center” 221, the regional data center determines if the received information corresponds to a sporting event served by the regional data center. If the received information corresponds to a location within the service area of the regional data center, that regional data center determines an allowable type of game play, e.g., real-money, social chips and/or fantasy, and sends a message back to the portable computer system 201 indicating what type(s) of game(s) are legal at the portable computer system 201's present location.

If the received information does not correspond to a sporting event served by the regional data center, that regional data center forwards the information to the regional data center responsible for the sporting event. In accordance with embodiments of the present location, such forwarding need not be exact or accomplished in a single “hop.” Instead, a regional data center receiving information not handled by the regional data center may forward the information to another regional data center believed to be “closer” or more accurate in responding to the information. In this novel manner, a given regional data center does not need to know details of all events covered by other data centers

Once information of the current sporting event is received at the correct data center, that data center sends a message back to computer system 201. The message may comprise dynamically computed odds for the sporting event, dynamically computed odds for a micro event within the sporting event, or the message may comprise information that enables the computer system 201 to dynamically determine the odds of the sporting event, or of a micro event within the sporting event.

The regional data centers 221, 222, 223, 224, 225 also play a role in resolving a wager, e.g., determining if the wager is won or lost. Such resolution may comprise receiving information of a live event, e.g., results of a play of a sporting event, from a data provider (not shown) via a communications network, e.g., the internet. The regional data centers 221, 222, 223, 224, 225 may compare the details of the wager with the information of the live event to determine the outcome of the wager, and to credit a user's account if the wager was successful. It is appreciated that the user's account is typically debited when the wager is placed, and that further action is not required when a wager is unsuccessful, or “loses.”

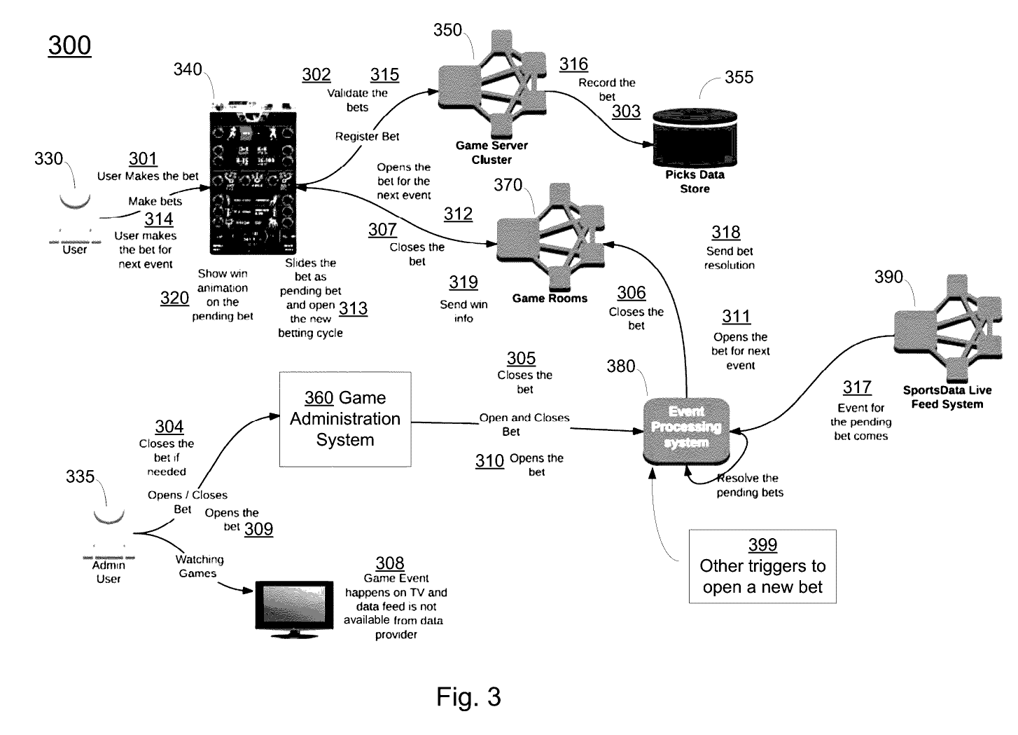

FIG. 3 illustrates an exemplary data flow 300 in a system for handling pending wagers, in accordance with embodiments of the present invention. In data flow 300, at 301 a user 330 enters or selects characteristics of a wager on a live event, e.g., sporting contest, via a computer system 340. Computer system 340 may be a portable or non-portable embodiment of exemplary electronic system 100 as illustrated in FIG. 1. The wager may be directed to a micro event, in some embodiments.

At 302, computer system 340 forwards information of the wager to game server cluster 350. Game server cluster 350 may be embodied on regional data centers 221, 222, 223, 224, and/or 225 as illustrated in FIG. 2. In general, game server cluster 350 performs the functions of collecting bets from a plurality of users, validating the bets, recording the bets in the data store 355 and associating the bets to the proper event. Game server cluster 350 is also responsible for deducting the bet amount from the user's game account balance. Game server cluster 350 validates the bet, e.g., confirms that the wager is allowable and that the user has sufficient funds in a user account to place the wager. Upon validation of the bet, the bet is registered, e.g., accepted by the host of the on-line wagering system. At 303, the bet is recorded onto picks data store 355. Picks data store 355 should comprise data security features commensurate with data storage for financial transactions. For example, data stored on picks data store 355 should not be erasable once written. Picks data store 355 may be embodied on regional data centers 221, 222, 223, 224, and/or 225 as illustrated in FIG. 2.

At 304, an administrative user 335 may close a bet, if necessary. For example, if a duration between plays is less than ordinarily allowed for by a wagering system, administrative user 335 may manually signal to game administration system 360 that a next play is about to occur, and wagers on that play may no longer be accepted. Administrative user 335 and/or administration system 360 may close a bet for other reasons, including, for example, that a total amount of wagers from all users has exceeded a wager limit. At 305, the administration system 360 signals the event processing system 380 that the bet has been closed. Administration system 360 may be embodied on regional data centers 221, 222, 223, 224, and/or 225 as illustrated in FIG. 2.

Also at 305, the event processing system 380 receives a signal from administration system 360 that a bet is closed. Event processing system 380 performs the functions of accessing the feed from the data provider 390 and converting that data into a normalized format. If information from data provider 390 is available for a particular pending micro event, event processing system 380 resolves all bets for the micro event for all users concurrently. Event processing system 380 also determines a score for each user based on the resolution of the bets, records the results in the data store 355, and sends the resolved event information to the game rooms server 370. Event processing system 380 may be embodied on regional data centers 221, 222, 223, 224, and/or 225 as illustrated in FIG. 2.

The game rooms server 370 performs the functions of grouping users into virtual game rooms corresponding to a specific game. Game rooms may be further subdivided, for example, to a group of friends watching and wagering on the same game. The event processing system 380 generally sends resolved bet information to the game rooms server 370 and game rooms server 370 delivers game information and bet resolution information to all the users in each room. The game rooms server 370 may be embodied on regional data centers 221, 222, 223, 224, and/or 225 as illustrated in FIG. 2.

At 307, game rooms server 370 communicates to computer system 330 that a bet, e.g., a betting opportunity, has been closed. This communication generally results in an indication to user 330 via a graphical user interface, although that is not required. For example, a user may not be notified of a closed bet unless the user attempts to wager on a closed micro event.

At 308, a play is completed. Detection of a completed play may be accomplished by any suitable means, including, for example, administrative user 335 observing the game, e.g., at the game venue, via closed circuit and/or broadcast radio and/or television, a timely indication of play completion from data provider 390, e.g., provided prior to more complete information on a play, video and/or audio signal recognition of the event broadcast, e.g., to recognize a play ending whistle sound, heuristic and/or artificial intelligence analysis of a game.

Detection of a completed play is entered into game administration system 360, or alternatively into event processing system 380 from other triggers 399. Communication to open a wagering opportunity progresses in a similar manner to that of closing a bet. For example, communication to open a bet flows at 310 to the event processing system 380, at 311 from event processing system 380 to the game rooms server 370, and at 312 from the game rooms server 370 to the computer system 340.

In general, it is appreciated that information from data provider 390 to resolve a pending wager may not be available prior to a time for closing a subsequent wager on a subsequent micro event or in time for opening a wager on a subsequent play. For example, a wager on a first play has not been resolved by the time for a next play. Accordingly, in accordance with embodiments of the present invention, at 313, in response to opening of a new wager 312 prior to resolution of a prior wager, the prior wager is displayed in a “pending wager” portion of a graphical user interface, and a display for entry of a new wager, e.g., a wager on a next play, is presented. In this novel manner, a plurality of wagers on a series of plays or micro events may be queued, while waiting for resolution of prior wagers. For example, a sequence of wagers is decoupled from the resolution of such wagers.

Alternatively, in accordance with embodiments of the present invention, after entry of a wager by user 330 into computer system 340, such wager may automatically be indicated as “pending” on computer system 340, and displayed in a “pending” portion of a graphical user interface. For example, placement into the “pending” portion of a graphical user interface is not dependent upon the opening of a subsequent wagering opportunity.

At 35, user 330 makes a bet on a next event, e.g., while one or more prior bets are pending, e.g., not yet resolved. The wager is handled as before, e.g., at 315, computer system 340 sends information of the bet to game server cluster 350, which validates and registers the bet, and at 316 records the bet onto picks data store 355.

At some point in time, for example after entry of a second or subsequent wager, at 317 data provider 390 sends information for a prior bet, e.g., the first exemplary bet, to event processing system 380. The information enables event processing system 380 to resolve the bet, sending, at 318, bet resolution information to game rooms server 370. Game rooms server 370 sends bet resolution information to computer system 340.

In an exemplary winning bet 319, computer system 340 displays winning information on a graphical user interface. In accordance with embodiments of the present invention, a graphical user interface may include an animation 320, for example, of a golden coin or betting chip moving from an area of pending wagers to an indication of a user's winnings, for example, to a user account balance display. In response to a loosing wager, the indication of the particular pending wager may be removed in a more subdued manner. It is appreciated that the user's account is typically debited when a wager is placed, and that no balance adjustment is required when a wager is unsuccessful, or “loses.”

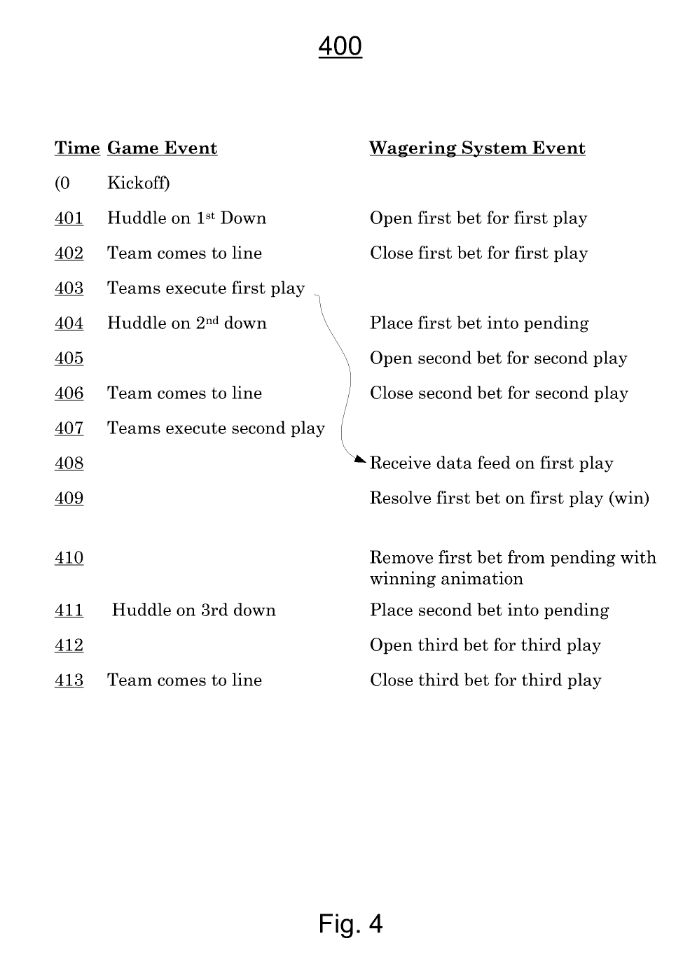

FIG. 4 illustrates an exemplary time line 400 of wagering system events corresponding to game events, in accordance with embodiments of the present invention. The indication time in time line 400 indicates sequence and not absolute time. The time indications are unit less, and are not meant to imply a same amount of time between listed events. In time line 400, the event at time sequence zero indicate a previous event, which serves as an arbitrary starting point in the exemplary game sequence.

At time sequence 401, an offensive team huddles on first down, and a first bet is opened corresponding to the next play, e.g., a first down play. As the team comes to the line at time sequence 402, the play is imminent, and the bet on the upcoming first play is closed. At time sequence 403, the teams execute the play. At time sequence 404, the offense huddles on second down. In preparation for opening betting on the next play, the first bet is placed into the pending portion of an on-screen graphical user interface. At time sequence 405, a second bet on the upcoming second play is opened.

As the team comes to the line at time sequence 406, the second play is imminent, and the bet on the upcoming second play is closed. At time sequence 407, the teams execute the play.

At time sequence 408, e.g., at some time after execution of the first play at time sequence 403, a data feed comprising information on the first play, e.g., from data provider 390 of FIG. 3, is received. At time sequence 409, the wager on the first play is resolved, based on the data feed. In this example, the user won the bet on the first play. At time sequence 410, the first bet is removed from the pending area of the graphical user interface. In accordance with embodiments of the present invention, a graphical user interface may include an animation, for example, of a golden coin or betting chip moving from an area of pending wagers to an indication of a user's winnings, for example, to an account balance display.

At time sequence 411, the offense huddles on third down. In preparation for opening betting on the next, third, play, the second bet is placed into the pending portion of a graphical user interface. At time sequence 412, a third bet on the upcoming third play is opened. As the team comes to the line at time sequence 413, the third play is imminent, and the bet on the upcoming third play is closed.

It is to be appreciated that the novel display of pending bet information, and opening new wagers while old wagers are pending, removes a sequential dependence on receipt of play result information. The play result information may be received asynchronously with respect to game flow and/or wager creation, in accordance with embodiments of the present invention.

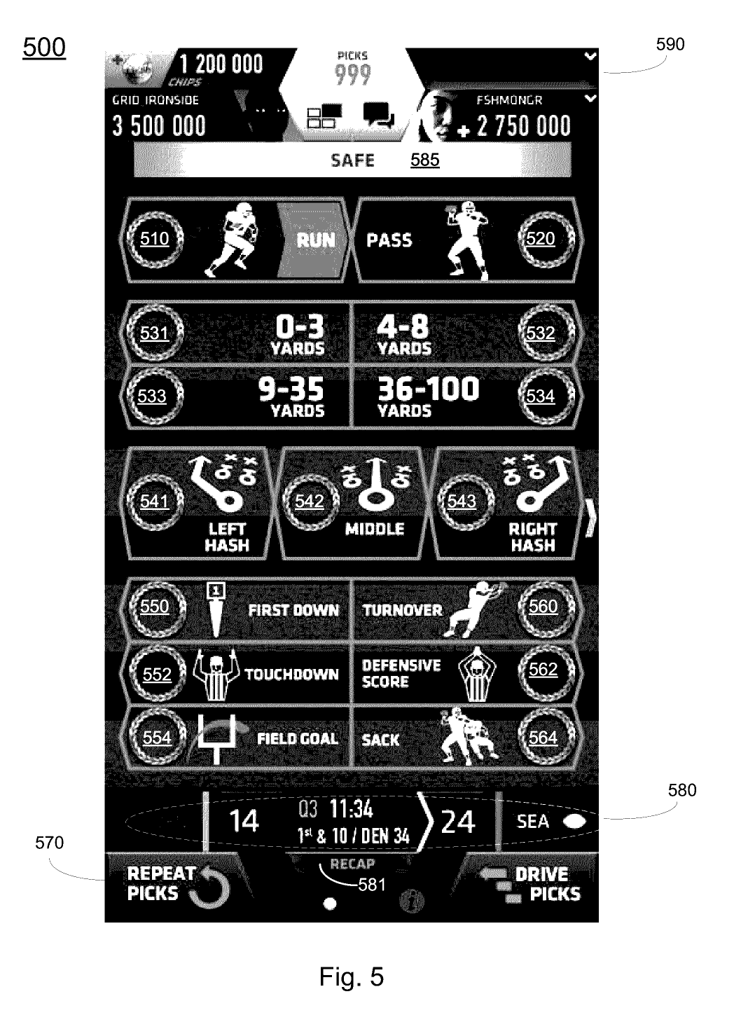

FIG. 5 illustrates an exemplary on-screen graphical user interface (GUI) 500 for placing a wager on team results of a micro event, in accordance with embodiments of the present invention. Graphical user interface 500 enables a user to specify a prediction of the results of a next play, e.g., a next micro event, at a team level. A user may predict a running play, e.g., that any player will run with the ball, via run icon 510, or may predict a passing play, e.g., that any player will legally catch a pass, via pass icon 520. A user may predict how many yards a play will gain, e.g., via 0-3 yards icon 531, 4-8 yards icon 532, 8-36 yards icon 533 and 36-100 yards icon 534. A user may also predict a direction of an upcoming play, e.g., left hash icon 541, middle icon 542, or right hash icon 543.

Graphical user interface 500 also comprises a “repeat picks” icon 570 for creating the same position on a subsequent micro event as was taken on an immediately preceding micro event. For example, if a user predicted a run up the left hash for 0-3 yards for the last play, touching the “repeat picks” icon 570 will establish a position of a run up the left hash for 0-3 yards for the next play. Graphical user interface 500 comprises a scoreboard display 580 presenting a variety of information on the status of a sporting contest, including, for example, game score, which team has the ball, time remaining, quarter, down, position on the field, yards to go, and the like.

Graphical user interface 500 comprises a group of “game event” icons 550, 552, 554, 560, 562 and 564. Game event icons 550, 552 and 554 are generally associated with offensive team achievements, while game event icons 1560, 562 and 564 are generally associated with defensive team achievements. Game event icons are used to predict offensive and/or defensive team achievements, in accordance with embodiments of the present invention. Game event icons are not exclusive of the other icons 510 through 543. For example, in a first scenario, a user may select only game event first down icon 550, indicating a prediction that the offense will achieve a first down, by any means. In a second scenario, a user may select game event first down icon 550 and run icon 510, indicating a prediction that that the offense will achieve a first down by running the ball. The latter prediction comprising a run for a first down is more specific that the former prediction of a first down by any means, and may have a greater likelihood factor, or odds, and a potentially larger payout for an equivalent wager. All such combinations that are consistent with the rules and structure of the current sporting event may be allowed. Some combinations, e.g., an offensive first down 550 coupled with a defensive sack 564 may not be allowed.

Game event first down icon 550 is used to enter a user prediction that a next play, e.g., a micro event, will result in a first down for the offense. Game event touch down icon 552 is used to enter a user prediction that a next play, e.g., a micro event, will result in a touch down for the offense. Game event field goal icon 554 is used to enter a user prediction that a next play, e.g., a micro event, will result in a field goal for the offense.

Game event turnover icon 560 is used to enter a user prediction that a next play, e.g., a micro event, will result in a turnover for the defense, e.g., the offense loses the ball. Game event defensive score icon 562 is used to enter a user prediction that a next play, e.g., a micro event, will result in a score, e.g., a safety or a touchdown, for the defense. Game event sack icon 564 is used to enter a user prediction that a next play, e.g., a micro event, will result in a sack for the defense.

Further, graphical user interface 500 comprises a recap button 581. Selection, e.g., by touching, of recap button 581 initiates a display of details of past plays and/or past wagers.

Graphical user interface 500 also comprises a time remaining indication bar 585. Once a bet is opened, time remaining indication bar 585 guides a user as to how much time is available to complete entry of a desired bet. Time remaining indication bar 585 may utilize color to indicate how much time is available to complete entry of a desired bet, in some embodiments. For example, presenting time remaining indication bar 585 in a green color may indicate that a relatively long amount of time is available to place a wager. Presenting time remaining indication bar 585 in a yellow color may indicate that a relatively lesser amount of time is available to place a wager. Presenting time remaining indication bar 585 in a red color may indicate that time available to place a wager is about to expire.

In addition to, or in place of, color coding, time remaining indication bar 585 may comprise textual information and/or iconography to indicate time remaining to place a bet, in some embodiments. For example, the text “SAFE” associated with time remaining indication bar 585 may indicate that a relatively long amount of time is available to place a wager. The text “WARNING” associated with time remaining indication bar 585 may indicate that a relatively lesser amount of time is available to place a wager. Presenting the text “DANGER” associated with time remaining indication bar 585 may indicate that time available to place a wager is about to expire.

In accordance with embodiments of the present invention, multiple wager selections of graphical user interface may be made independently of each other, in any number and/or combination. For example, a user may select both run icon 510 and pass icon 520 to wager on both outcomes of a micro event. Similarly, a user may select all three or no play direction icons.

Graphical user interface 500 comprises a dedicated on-screen region for displaying pending wagers 590. Region 590 may be visually demarcated from other portions of graphical user interface 500, for example, by color and/or shading. As illustrated in FIG. 5 there are no pending wagers. When there are no pending wagers, region 590 may be blank, or may comprise a textual message to the effect that there are no pending wagers or “picks.” The textual message may be presented in reduced contrast, in some embodiments.

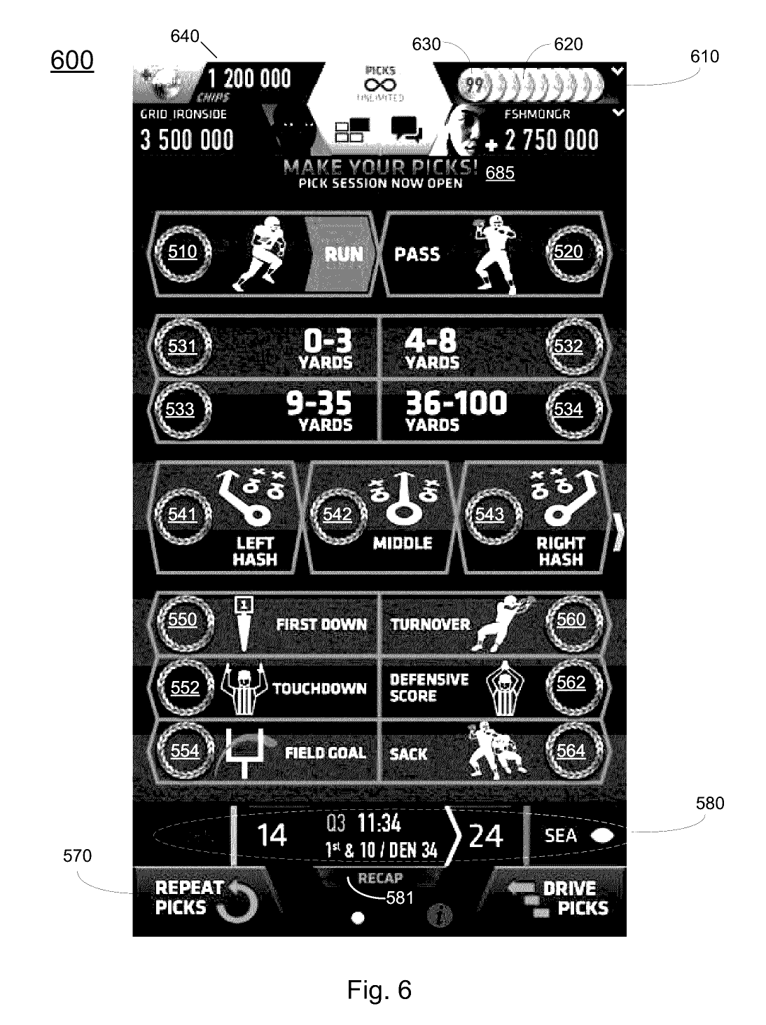

FIG. 6 illustrates an exemplary on-screen graphical user interface (GUI) 600 for placing a wager on team results of a micro event, in accordance with embodiments of the present invention. Graphical user interface 600 is similar to graphical user interface 500 and presents similar functionality via a plurality of icons.

Graphical user interface 600 comprises a time remaining indication bar 685. As illustrated in FIG. 6, time remaining indication bar 685 includes a textual message, for example, “MAKE YOUR PICKS! PICK SESSION NOW OPEN,” signifying an initial available of a wagering opportunity. In some embodiments, time remaining indication bar 685 may be presented on a graphical user interface to indicate to a user that a betting opportunity has opened, e.g., responsive to a open bet signal 312 as illustrated in FIG. 3 and/or an open bet signal at time sequence 401 as illustrated in FIG. 4.

Graphical user interface 600 further comprises a region 610 dedicated to displaying information related to pending wagers. Region 610 may be visually demarcated from other portions of graphical user interface 600, for example, by color and/or shading. If there are no pending wagers, region 610 may be blank, or may comprise a textual message to the effect that there are no pending wagers or “picks.” FIG. 5 illustrated a comparable region 590 (FIG. 5) displaying no pending wagers. When a new betting opportunity is opened prior to resolution of a previous bet, a pending wager icon 620 is displayed within region 610. Pending wager icon 620 may also comprise a numerical representation 630 of a number of pending wagers, in some embodiments. In the example of graphical user interface 600, 99 pending wagers are illustrated.

In accordance with embodiments of the present invention, a pending wager icon, e.g., pending wager icon 620, may comprise a symbolic representation of a coin, e.g., a gold coin, or betting chip. In accordance with embodiments of the present invention, the pending wager icon 620 may comprise a stack of coins and/or chips, as illustrated.

When a pending bet is resolved, the numerical representation 630 is adjusted, e.g., decreased, to reflect a new number of pending wagers. If the bet was a winning bet, an animation of a portion of pending wager icon, e.g., a coin and/or a chip, moving from the pending wagers icon 610 to the user account balance display 640 may be displayed, in some embodiments. A user account balance display 640 may include a display of holdings in a real currency, a virtual currency, e.g., “chips,” points and/or score, in some embodiments. In some embodiments, the animation may include incrementing the user account balance display 640 by the winning amount. In accordance with embodiments of the present invention, a user's account may be debited when a wager is placed, and that no balance adjustment is required when a wager is unsuccessful, or “loses.” For a resolution of a loosing bet, the numerical representation 630 may be adjusted without animation and without adjusting user account balance display 640.

In accordance with embodiments of the present invention, numerical representation 630 may not display zero, e.g., no pending wagers. When there are no longer any pending wagers, e.g., all pending wagers have been resolved, pending wager icon 620 may be removed, and the region 610 may revert to an image similar to region 590 displaying no pending wagers, as illustrated in FIG. 5.

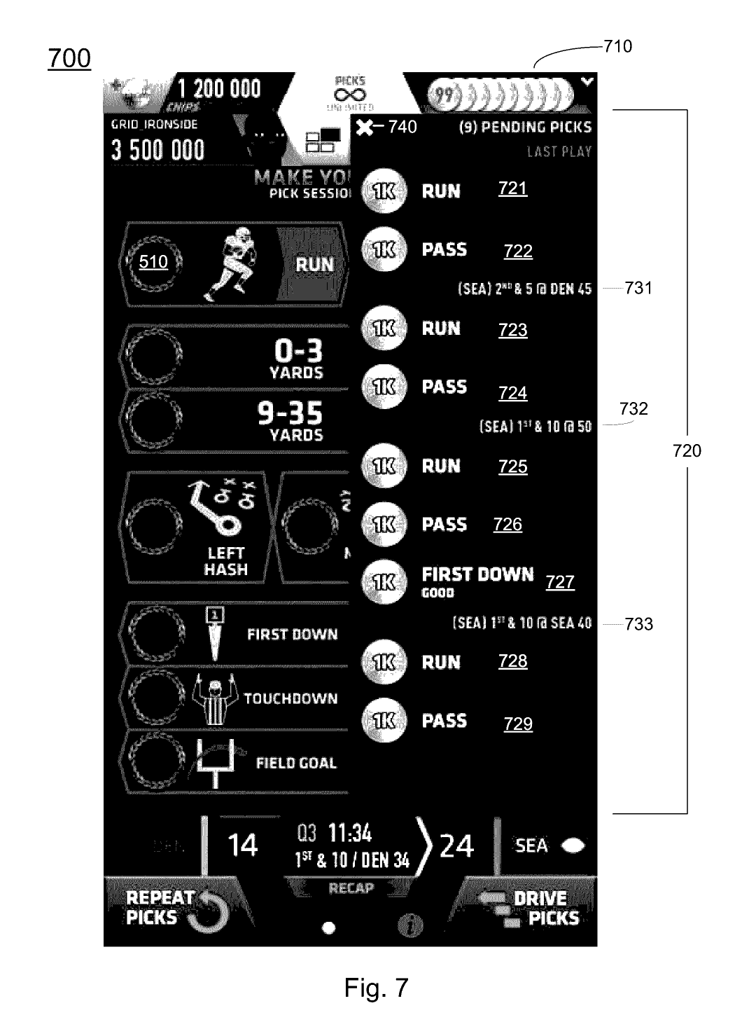

FIG. 7 illustrates an exemplary on-screen graphical user interface (GUI) 700, in accordance with embodiments of the present invention. Graphical user interface comprises a region 710 dedicated to displaying information related to pending wagers. The region 710 is similar to region 610, as illustrated in FIG. 6. Touching or otherwise indicating within region 710 causes display of pending wagers 720 to “pop up” over other elements of graphical user interface 700, e.g., icons and graphics as illustrated in graphical user interface 600 of FIG. 6. Some or all remaining elements of graphical user interface 700 that are not obscured by display of pending wagers 720 may be dimmed, e.g., displayed with reduced visual intensity, relative to the display of pending wagers 720 and/or relative to their intensity of FIG. 6, in accordance with embodiments of the present invention. For example, wager entry areas, e.g., run icon 510, may be dimmed, while region 710 is not dimmed.

Exemplary display of pending wagers 720 comprises an exemplary list of pending wager detail displays 721 through 729 of each of the pending wagers. There may be a pending wager detail display for every pending wager, in some embodiments. In some embodiments, the list of pending wager detail displays may page or scroll to display more paneling wager details. In the embodiment of FIG. 7, the oldest pending wager is at the bottom of the list, e.g., pending wager detail display 729, while the most recent pending wager is at the top of the list, e.g., pending wager detail display 721, although this order is not required, and other orderings are well-suited to embodiments in accordance with the present invention.

A pending wager detail display comprises a detailed display of a wager, e.g., pass, run, yardage gained, play direction, first down, touchdown, field goal, turnover, defensive score and/or sack, and an amount wagered, e.g., 1,000 (“1k”) chips. Each pending wager detail display may show all the details of the play characteristics, player(s) and/or team picks of a particular wager. For example, pending wager detail display 729 indicates a bet of 1,000 chips that a (first, in this exemplary sequence) play would be a pass. Pending wager detail display 728 indicates a bet of 1,000 chips that the same play would be a run. It is appreciated that making multiple wagers, even conflicting wagers, for a same play is straight-forward using embodiments of the present invention, for example, graphical user interface 500 of FIG. 5. For example, a user may have selected both team run icon 510 and team pass icon 520 to generate (pending) wagers as indicated in pending wager detail displays 728 and 729.

Display of pending wagers 720 may also comprise play results displays, for example, play result displays 731, 732, and 733. If available, e.g., from data provider 390 of FIG. 3, play result displays may indicate results of plays. Note that the presence of play results does not necessarily require that a bet has been resolved. Play result display 733 indicates that, as a result of the play, the Seahawks have the ball on their 40 yard line, first down and ten yards to go. It is to be appreciated that the presence of wager detail displays 728 and 729 indicates that the subject bets have not been resolved. For example, the wagering system does not know whether the play was a run or a pass, or how many yards were gained.

Pending wager detail displays 725, 726 and 727 indicate that a user placed a bet for 1,000 chips that a subsequent (second) play would be a pass and placed a bet for 1,000 chips that the same play would be a run, and placed a bet for 1,000 chips that the result of the play would be a first down. Play result display 732 indicates that, as a result of the play, the Seahawks have the ball on the 50 yard line, first down and ten yards to go.

Pending wager detail displays 723 and 724 indicate that a user placed a bet for 1,000 chips that a subsequent (third) play would be a pass and placed a bet for 1,000 chips that the same play would be a run. Play result display 731 indicates that, as a result of the play, the Seahawks have the ball on the opponent's 45 yard line, second down and five yards to go. Pending wager detail displays 723 and 724 indicate that a user placed a bet for 1,000 chips that a subsequent (fourth) play would be a pass and placed a bet for 1,000 chips that the same play would be a run. No play results for the fourth play are listed.

Touching or otherwise indicating window close icon 740 dismisses display of pending wagers 720, restoring a graphical user interface similar to graphical user interface 600 of FIG. 6.

In this novel manner, a user may review pending wagers at any point during their pendency.

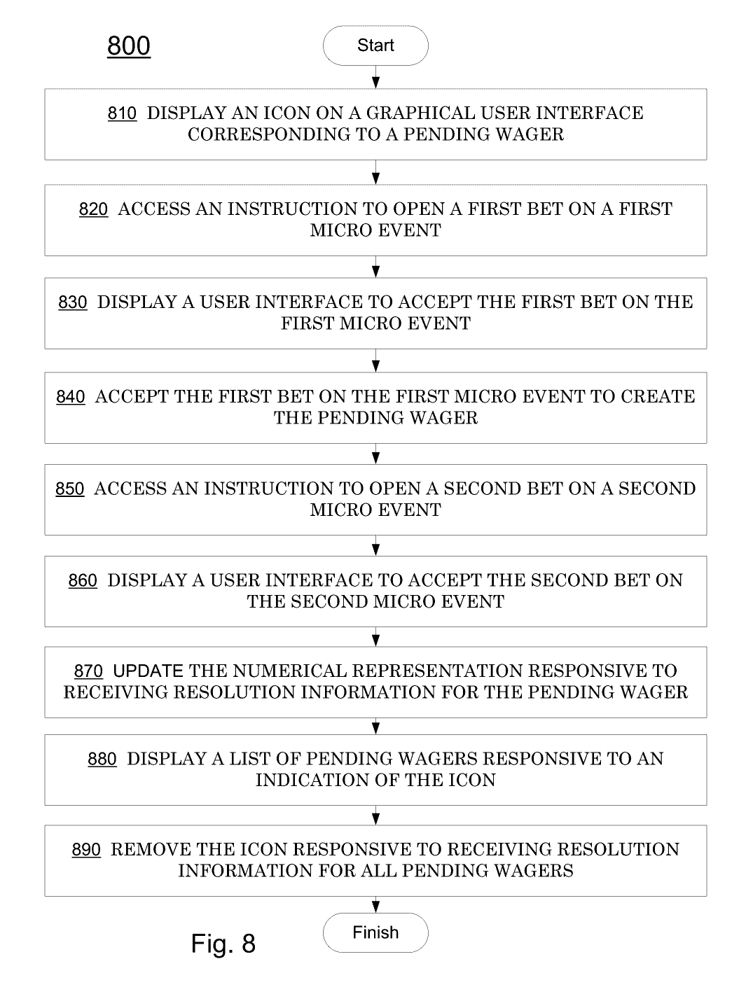

FIG. 8 illustrates an exemplary computer-implemented method 800, in accordance with embodiments of the present invention. In 810, an icon corresponding to a pending wager is displayed on a graphical user interface. The icon comprises a numerical representation of a number of currently pending wagers. Displaying the icon may be responsive to the accessing of an instruction to open the second bet on the second micro event. Displaying the icon may be responsive to the accessing of an instruction to open the second bet on the second micro event prior to resolving the accepted wager. Displaying the icon may be responsive to the accessing an instruction to open the second bet on the second micro event prior to resolving the accepted wager. In optional 820, an instruction to open a first bet on a first micro event is accessed.

In optional 830, a user interface to accept the first bet on the first micro event is displayed. In optional 840, the first bet on the first micro event is accepted to create the pending wager. In optional 850, an instruction to open a second bet on a second micro event is accessed. In optional 860, a user interface to accept the second bet on the second micro event is displayed. In optional 870, the numerical representation is updated responsive to receiving resolution information for the pending wager. Updating the icon may include an animation of a portion of the icon moving from a first position to a display of a user account balance. The animation may include updating a user account balance to reflect a result of the accepted wager.

In optional 880, a list of pending wagers is displayed responsive to an indication of, e.g., touching, the icon. In optional 890, the icon is removed responsive to receiving resolution information for all pending wagers, e.g., resulting in a display region similar to region 590 as illustrated in FIG. 5.

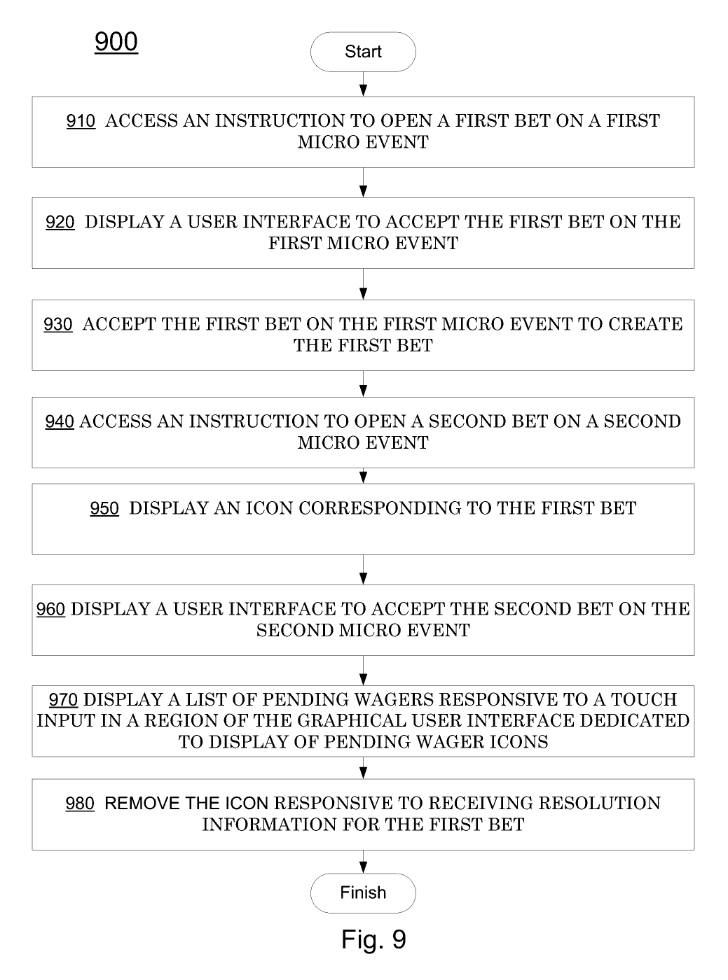

FIG. 9 illustrates an exemplary computer-implemented method 900, in accordance with embodiments of the present invention. In optional 910, an instruction to open a first bet on a first micro event is accessed. In 920, a user interface to accept the first bet on the first micro event is displayed.

In optional 930, the first bet on the first micro event is accepted to create the first bet. In 940, an instruction to open a second bet on a second micro event is accessed. In 950, an instruction to open a second bet on a second micro event is accessed. In 960, a user interface to accept the second bet on the second micro event is displayed. The icon may also correspond to a pending wager, e.g., a wager placed prior to a current wager. Displaying the icon may be responsive to the instruction to open the second bet on the second micro event. Displaying the icon may be responsive to the instruction to open the second bet on the second micro event prior to resolving the accepted wager. Displaying the icon may be responsive to the instruction to open the second bet on the second micro event prior to resolving the accepted wager.

In optional 970, a list of pending wagers is displayed responsive to a touch input in a region of the graphical user interface dedicated to display of pending wager icons. In optional 980, the icon is removed responsive to receiving resolution information for the first bet. Removing the icon may include an animation of the icon moving. The animation may include moving the icon from a first position to a display of a user account balance. The animation may include updating a user account balance to reflect a result of the accepted wager.

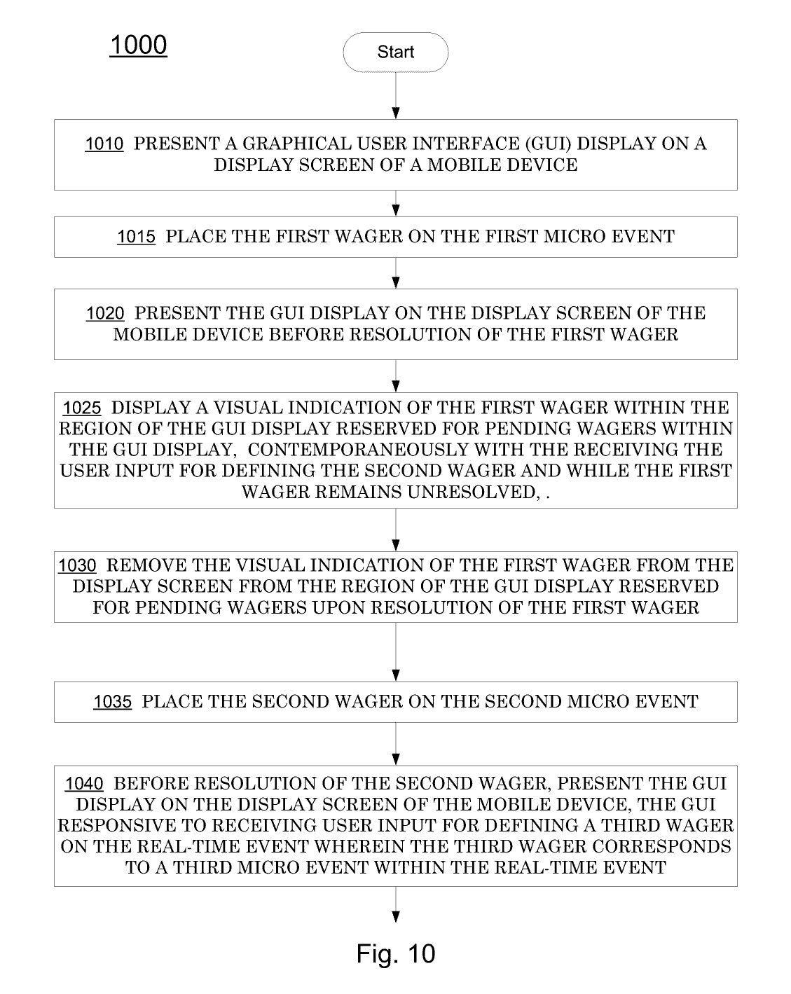

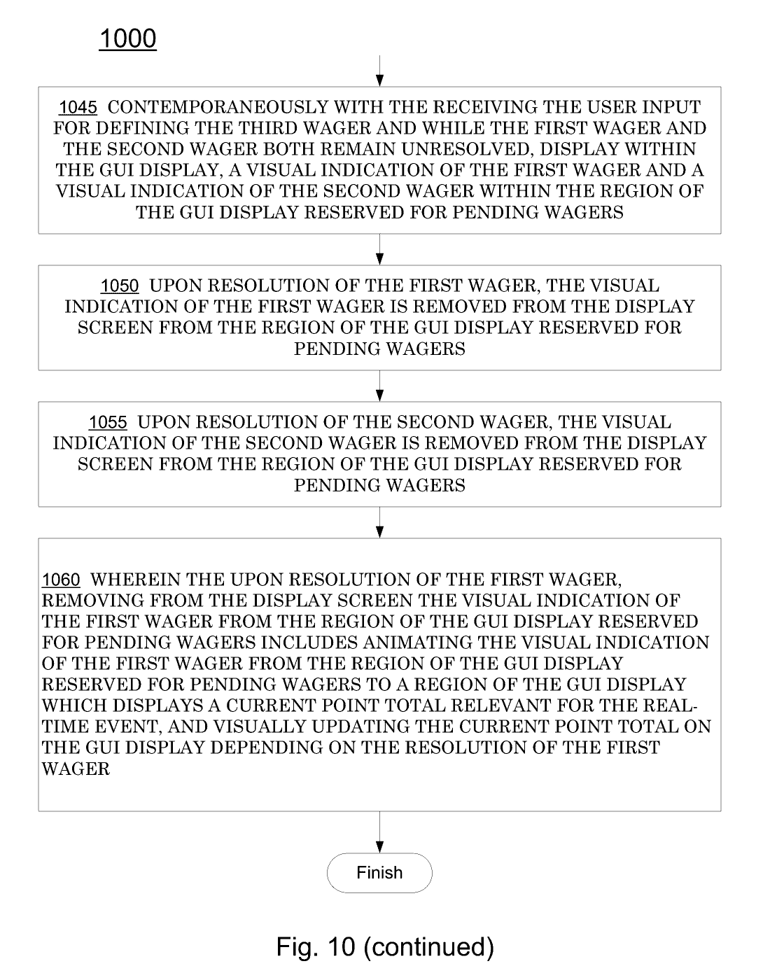

FIG. 10 illustrates an exemplary computer-implemented method of wagering 1000, in accordance with embodiments of the present invention. In 1010, a graphical user interface (GUI) display is presented on a on a display screen of a mobile device. The GUI is responsive to user input for defining a first wager on a real-time event wherein the first wager corresponds to a first micro event within the real-time event.

In 1015, the first wager is placed on the first micro event. In 1020, before resolution of the first wager, the GUI display is presented on the display screen of the mobile device. The GUI is responsive to receiving user input for defining a second wager on the real-time event wherein the second wager corresponds to a second micro event within the real-time event.

In 1025, contemporaneously with the receiving the user input for defining the second wager and while the first wager remains unresolved, a visual indication of the first wager is displayed within the GUI display. The region of the GUI display is reserved for displaying pending wagers. The visual indication may be an image of a currency type, in some embodiments. For example, the visual indication may be of a legal tender coin, a token, and/or a betting chip.

In optional 1030, upon resolution of the first wager, the visual indication of the first wager is removed from the display screen from the region of the GUI display reserved for pending wagers. In optional 1035, the second wager is placed on the second micro event. In optional 1040, before resolution of the second wager, the GUI display is presented on the display screen of the mobile device. The GUI is responsive to receiving user input for defining a third wager on the real-time event wherein the third wager corresponds to a third micro event within the real-time event. In optional 1045, contemporaneously with the receiving the user input for defining the third wager and while the first wager and the second wager both remain unresolved, a visual indication of the first wager and a visual indication of the second wager are displayed within the GUI display within the region of the GUI display reserved for pending wagers.

In optional 1050, upon resolution of the first wager, the visual indication of the first wager is removed from the display screen from the region of the GUI display reserved for pending wagers. In optional 1055, upon resolution of the second wager, the visual indication of the second wager is removed from the display screen from the region of the GUI display reserved for pending wagers. In optional 1060, the removal of the visual indication of the first wager from the display screen from the region of the GUI display reserved for pending wagers upon resolution of the first wager further includes animating the visual indication of the first wager from the region of the GUI display reserved for pending wagers to a region of the GUI display which displays a current point total relevant for the real-time event and visually updating the current point total on the GUI display depending on the resolution of the first wager.

Embodiments in accordance with the present invention provide methods, systems and graphical user interfaces for handling pending wagers. In addition, embodiments in accordance with the present invention provide methods, systems and graphical user interfaces for pending wagers that decouple subsequent wagering from the resolution of prior wagers. Also, embodiments in accordance with the present invention provide methods, systems and graphical user interfaces for pending wagers that indicate a number and/or order of pending wagers. Further, embodiments in accordance with the present invention provide methods, systems and graphical user interfaces for pending wagers that are compatible and complementary with existing systems and methods of on-line and/or mobile gaming platforms.

Various embodiments of the invention are thus described. While the present invention has been described in particular embodiments, it should be appreciated that the invention should not be construed as limited by such embodiments, but rather construed according to the below claims.

What is claimed is:

1. A computer implemented method comprising:
displaying an icon on a graphical user interface corresponding to a pending wager, wherein said icon comprises a numerical representation of a number of currently pending wagers.

2. The computer implemented method of claim 1 further comprising:
accessing an instruction to open a first bet on a first micro event;
displaying a user interface to accept said first bet on said first micro event;
accepting said first bet on said first micro event to create said pending wager;
accessing an instruction to open a second bet on a second micro event; and
displaying a user interface to accept said second bet on said second micro event.

3. The computer implemented method of claim 2 wherein said displaying said icon is responsive to said accessing an instruction to open said second bet on said second micro event.

4. The computer implemented method of claim 3 wherein said displaying said icon is responsive to said accessing an instruction to open said second bet on said second micro event prior to resolving said pending wager.

5. The computer implemented method of claim 1 further comprising updating said numerical representation responsive to receiving resolution information for said pending wager.

6. The computer implemented method of claim 5 further comprising removing said icon responsive to resolution of all pending wagers.

7. The computer implemented method of claim 5 further comprising an animation of a portion of said icon moving from a first position to a display of a user account balance.

8. The computer implemented method of claim 7 wherein said animation comprises updating a user account balance to reflect a result of said accepted wager.

9. The computer implemented method of claim 1 further comprising:
responsive to an indication of said icon, displaying a list of pending wagers.

10. A mobile electronic system comprising:
one or more processors coupled to a bus;
a memory coupled to said one or more processors, wherein said memory comprises a gaming application;
a graphical user interface coupled to said bus;
wherein said mobile electronic system is configured to:
display a user interface to accept a first bet on a first micro event;
access an instruction to open a second bet on a second micro event;
display an icon corresponding to said first bet; and
display a user interface to accept said second bet on said second micro event.

11. The mobile electronic system of claim 10 wherein said display of said icon is responsive to said instruction to open a second bet on a second micro event.

12. The mobile electronic system of claim 11 wherein said display of said icon is responsive to said instruction to open a second bet on a second micro event prior to receiving resolution information for said first bet.

13. The mobile electronic system of claim 10 wherein said icon is displayed in a region of said graphical user interface dedicated to display of pending wager icons.

14. The mobile electronic system of claim 13 further configured to display a list of pending wagers responsive to a touch input in said region.

15. The mobile electronic system of claim 13 further configured to change said icon responsive to receiving resolution information for said first bet.

16. The mobile electronic system of claim 15 further configured to animate moving a portion of said icon from said region to a different region of said graphical user interface responsive to receiving said resolution information for said first bet.

17. The mobile electronic system of claim 16 wherein said different region comprises a display of a user account balance.

18. The mobile electronic system of claim 17 further configured to update an amount displayed in said display of a user account balance to reflect a result of said first bet.

19. A graphical user interface comprising:
a first region for indicating details of a wager on a future micro event; and
a second region for displaying an icon indicative of at least one wager on a prior micro event pending resolution.

20. The graphical user interface of claim 19 wherein said second region further comprises a numerical indication of a number of pending wagers.

21. The graphical user interface of claim 19 wherein said second region is in an upper right portion of said graphical user interface.

22. The graphical user interface of claim 19 wherein said second region is visually demarcated from remaining portions of said graphical user interface.

23. The graphical user interface of claim 19 wherein said second region comprises a different color at its borders in comparison to any adjacent other regions of said graphical user interface.

24. The graphical user interface of claim 19 wherein said second region does not comprise an icon.

25. The graphical user interface of claim 19 further configured to display a list of all pending wagers responsive to a touch input in said second region.

26. The graphical user interface of claim 25 wherein said list is displayed over at least a portion of said first region.

27. The graphical user interface of claim 26 wherein any portions of said graphical user interface not displaying said list are displayed at a diminished visual intensity.

28. The graphical user interface of claim 21 further configured to adjust said numerical indication responsive to resolution of a pending wager.

29. The graphical user interface of claim 21 further comprising an animation of a portion of said icon moving out of said second region responsive to resolution of a pending wager.

30. The graphical user interface of claim 29 wherein said animation further comprises moving said icon from said second region to a third region displaying a user account balance.

31. The graphical user interface of claim 29 wherein said animation further comprises updating said user account balance display to reflect results of said wager.

32. The graphical user interface of claim 19 wherein said at least one icon remains displayed in said second region until said prior micro event is resolved.

33. A non-transitory computer-readable medium having instructions stored thereon that, responsive to execution by an electronic system, cause said electronic system to perform operations comprising:
first displaying a user interface to accept a first bet on a first micro event;
receiving an instruction to open a second bet on a second micro event;
second displaying an icon corresponding to said first bet; and
third displaying a user interface to accept said second bet on said second micro event.

34. A method of wagering, said method comprising:
presenting a graphical user interface (GUI) display on a display screen of a mobile device, said GUI responsive to user input for defining a first wager on a real-time event wherein said first wager corresponds to a first micro event within said real-time event;
placing said first wager on said first micro event;
before resolution of said first wager, presenting said GUI display on said display screen of said mobile device, said GUI responsive to receiving user input for defining a second wager on said real-time event wherein said second wager corresponds to a second micro event within said real-time event; and
contemporaneously with said receiving said user input for defining said second wager and while said first wager remains unresolved, displaying within said GUI display, a visual indication of said first wager within said region of said GUI display reserved for pending wagers.

35. The method as described in claim 34 further comprising, upon resolution of said first wager, removing from said display screen said visual indication of said first wager from said region of said GUI display reserved for pending wagers.

36. The method as described in claim 35 wherein said visual indication comprises a numerical representation of a total number of pending wagers.

37. The method as described in claim 36 further comprising:
placing said second wager on said second micro event;
before resolution of said second wager, presenting said GUI display on said display screen of said mobile device, said GUI responsive to receiving user input for defining a third wager on said real-time event wherein said third wager corresponds to a third micro event within said real-time event; and
contemporaneously with said receiving said user input for defining said third wager and while said first wager and said second wager both remain unresolved, adjusting within said GUI display, said numerical representation to account for said first wager and said second wager within said region of said GUI display reserved for pending wagers.

38. The method as described in claim 37 further comprising:
upon resolution of said first wager, adjusting said numerical representation to remove said first wager from said region of said GUI display reserved for pending wagers; and
upon resolution of said second wager, adjusting said numerical representation to remove said second wager from said region of said GUI display reserved for pending wagers.

39. The method as described in claim 38 wherein said upon resolution of said first wager, adjusting said numerical representation to remove said first wager from said region of said GUI display reserved for pending wagers comprises:
animating said visual indication of said first wager from said region of said GUI display reserved for pending wagers to a region of said GUI display which displays a current point total relevant for said real-time event; and
visually updating said current point total on said GUI display depending on said resolution of said first wager.

40. The method as described in claim 39 further comprising responsive to a user interaction with said visual indication of said first wager within said region of said GUI display reserved for pending wagers, displaying another GUI comprising details of said first wager.

41. The computer implemented method of claim 7 wherein said display of a user account balance comprises a display of holdings in one of a real currency, a virtual currency, points and score.
